(19) United States
(12) Patent Application Publication
(10) Pub. No.: US 2010/0170149 A1
(43) Pub. Date: Jul. 8, 2010

(54) ALGAE PRODUCTION SYSTEMS AND ASSOCIATED METHODS

(76) Inventors: Christopher C. Keeler, Gilbert, AZ (US); Jerry D. Stephenson, Queen Creek, AZ (US); Steven W. Schenk, Chandler, AZ (US); George Benjamin Cloud, Chandler, AZ (US); Souren Naradikian, Phoenix, AZ (US); Stephen W. Irwin, Avondale, AZ (US)

Correspondence Address: PERKINS COIE LLP;PATENT-SEA, P.O. BOX 1247, SEATTLE, WA, 98111-1247, US

(21) Appl. No.: 12/502,993

(22) Filed: Jul. 14, 2009

Related U.S. Application Data
(60) Provisional application No. 61/087,599, filed on Aug. 8, 2008.
(60) Provisional application No. 61/087,603, filed on Aug. 8, 2008.

(51) Int. Cl. A01G 7/00

(52) U.S. Cl. 47/1.4

(57) ABSTRACT

Algae production systems and associated methods are disclosed herein. In one embodiment, for example, an algae production system can include a plurality of elongated growth receptacles arranged in a desired configuration at a work site. The growth receptacles have a generally non-circular cross-sectional profile and are configured to hold an algae culture, and wherein the individual growth receptacles have a generally non-circular cross-sectional profile. The system can also include a carbon dioxide (CO₂) subsystem configured to supply provide CO₂-enriched air to the growth receptacles, a fresh medium subsystem configured to supply a fertility solution to the growth receptacles, and a harvesting subsystem.

### CROSS-REFERENCE TO RELATED APPLICATION

This application claims priority to U.S. Provisional Application No. 61/087,599, filed Aug. 8, 2008, and U.S. Provisional Application No. 61/087,603, filed Aug. 8, 2008, both of which are incorporated herein by reference in their entirety.

### TECHNICAL FIELD

The present disclosure is directed generally to algae production systems and associated methods.

### BACKGROUND

Algae is increasingly becoming an important source of biofuel oil to alleviate the supply shortages and high prices associated with traditional feedstock sources such as soybean, palm, canola, animal fats, etc. In many current applications, for example, the feedstock component is responsible for approximately 60 to 80 percent of the total cost of biofuel production. Accordingly, an affordable and readily available supply of feedstock is important for continued growth of the biofuels industry. Compared to other terrestrial crops (e.g., soybeans), algae produces approximately 30 to 200 times more oil, while requiring approximately 1/100th of the amount of water to grow per surface area. In addition, the non-oil components (e.g., carbohydrates and proteins) remaining after oil extraction from algae can be used for a variety of other applications-inputs into animal feed, fish feed, fertilizers, dyes, etc. or used to produce fuels/energy through fermentation, gasification, and anaerobic digestion. These additional applications greatly enhance the overall marketability and economics of producing algae.

Algae consumes inputs like sunlight, water, carbon dioxide (CO₂) and nutrients, and can generally be cultivated on land not suitable for other purposes. Algae's ability to ingest CO₂ and produce oxygen through photosynthesis is particularly attractive as a means to curtail carbon emissions. Despite these benefits, however, algae production has yet to materialize in any meaningful volume. One reason for the lack of market adoption may be the significant costs associated with building and maintaining an algae production and harvesting system. Although algae is easy to grow in small volumes (e.g., laboratory systems), to date this process has not been easily extrapolated into large-scale architectures producing consistent algae yields over long periods of time. Open architecture approaches (e.g., ponds or racetracks) are generally the least expensive technique, but often suffer from problems associated with contamination, evaporation, temperature control, CO₂ utilization, and general maintenance. Closed architecture approaches (so-called “photobioreactors”) generally include glass or plastic enclosures in which the algae fluid remains in a closed environment to enable accelerated growth and maintain better control over environmental conditions. Conventional large-volume photobioreactor installations typically include complex, elaborate systems that are costly to install and maintain.

### BRIEF DESCRIPTION OF THE DRAWINGS

FIG. 1 is a partially schematic, top isometric view of an algae production system configured in accordance with an embodiment of the disclosure.

FIG. 2 is a side, cross-sectional view taken substantially along lines 2-2 of FIG. 1 of a tube configured for use with the algae production system.

FIG. 3 is a side, cross-sectional view of a trough configured for use with the algae production system of FIG. 1 in accordance with another embodiment of the disclosure.

FIGS. 4A-4D are schematic, top plan views of an algae production facility or subfarm configured in accordance an embodiment of the disclosure.

### DETAILED DESCRIPTION

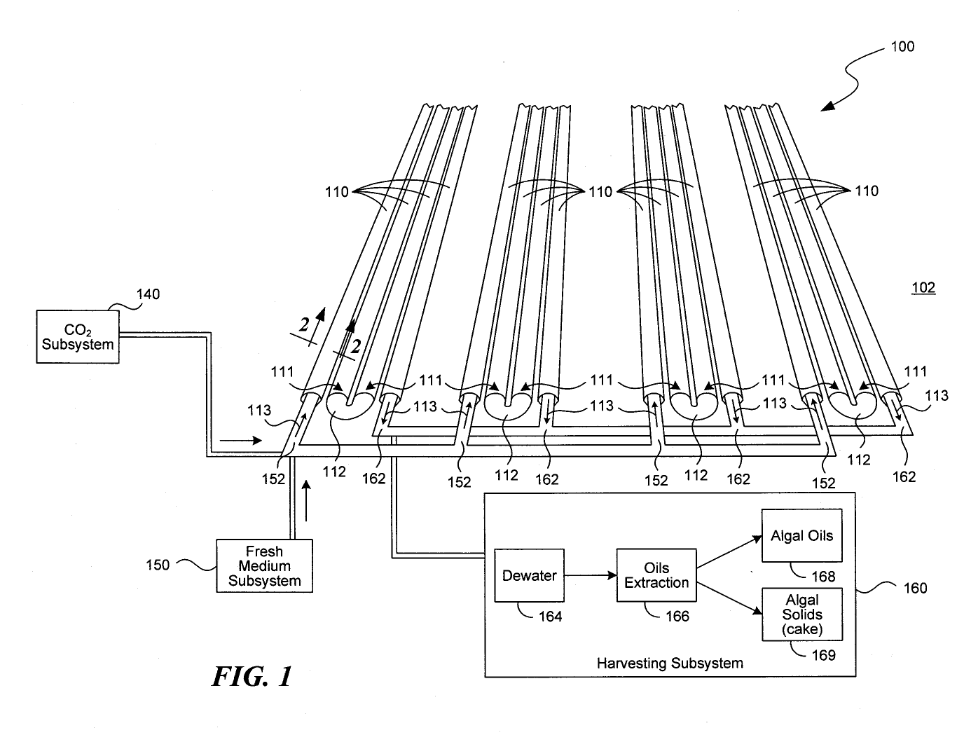

The present disclosure describes algae production systems and associated methods. Many specific details are set forth in the following description and in FIGS. 1-4D to provide a thorough understanding of various embodiments of the disclosure. Other details describing well-known structures and systems often associated with such systems, however, are not set forth below to avoid unnecessarily obscuring the description of the various embodiments of the disclosure.

Many of the details and features shown in the Figures are merely illustrative of particular embodiments of the disclosure. Accordingly, other embodiments can have other details and features without departing from the spirit and scope of the present disclosure. In addition, those of ordinary skill in the art will understand that further embodiments can be practiced without several of the details described below. Furthermore, various embodiments of the disclosure can include structures other than those illustrated in the Figures and are expressly not limited to the structures shown in the Figures. Moreover, the various elements and features illustrated in the Figures may not be drawn to scale.

FIG. 1 is a partially schematic, top isometric view of an algae production system 100 configured in accordance with one embodiment of the disclosure. The system 100 includes a plurality of generally flexible, non-circular tubes or troughs 110 arranged in a desired pattern over a work site 102. As described in greater detail below, the tubes or troughs 110 are configured to function as growth containers or receptacles for a flow of an algae culture or medium under continuous aeration for a desired cultivation period (e.g., 48 hours). The system 100 also includes (a) a CO₂ subsystem 140 (shown schematically) operably coupled to the tubes 110 and configured to provide CO₂-enriched air to the system 110 at one or more ends of the tubes 110 to aerate the tubes 110, and (b) a fresh medium subsystem 150 (shown schematically) operably coupled to the tubes 110 and configured to provide a fertility solution (not shown) containing water, nutrients (e.g., nitrogen, phosphorous, potassium (N—P—K), and micronutrients), and, in some instances, a small portion of algae to the tubes 110. The system 100 further includes a harvesting subsystem 160 (shown schematically) operably coupled to the tubes 110 and configured to receive the algae cultures for further processing (e.g., dewatering, oils extraction, etc.) after the desired growing period. Compared with complex and expensive conventional photobioreactor installations described previously, the system 100 is expected to cost significantly less to both install and maintain, while simultaneously providing increased algae output.

The work site 102 can include a wide variety of different types of terrain that have been previously leveled and prepared (e.g., using conventional agriculture hardware and practices). The work site 102 functions as a low-cost supporting structure for the tubing 110 and other system components, as well as providing thermal management for the system 100. One advantage of the system 100 is that the system can be installed and operated in a variety of different environments, including environments that are not suitable for conventional agricultural applications.

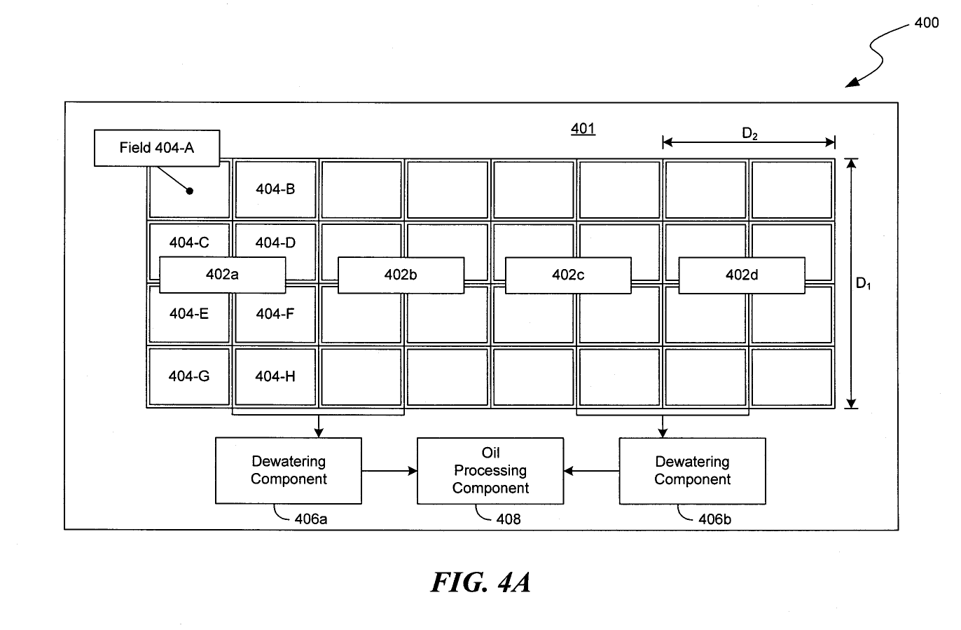

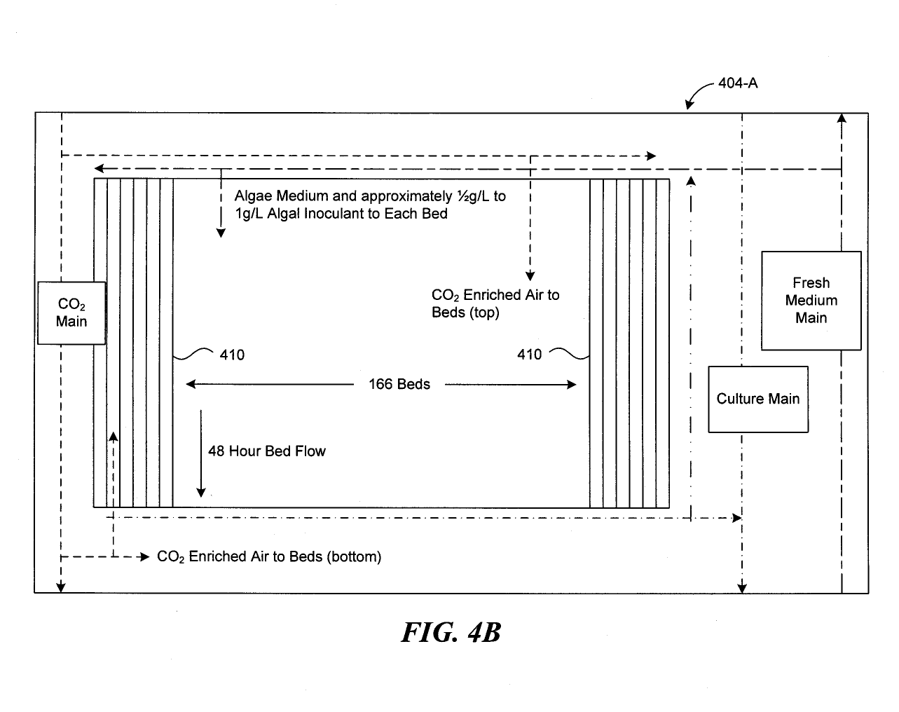

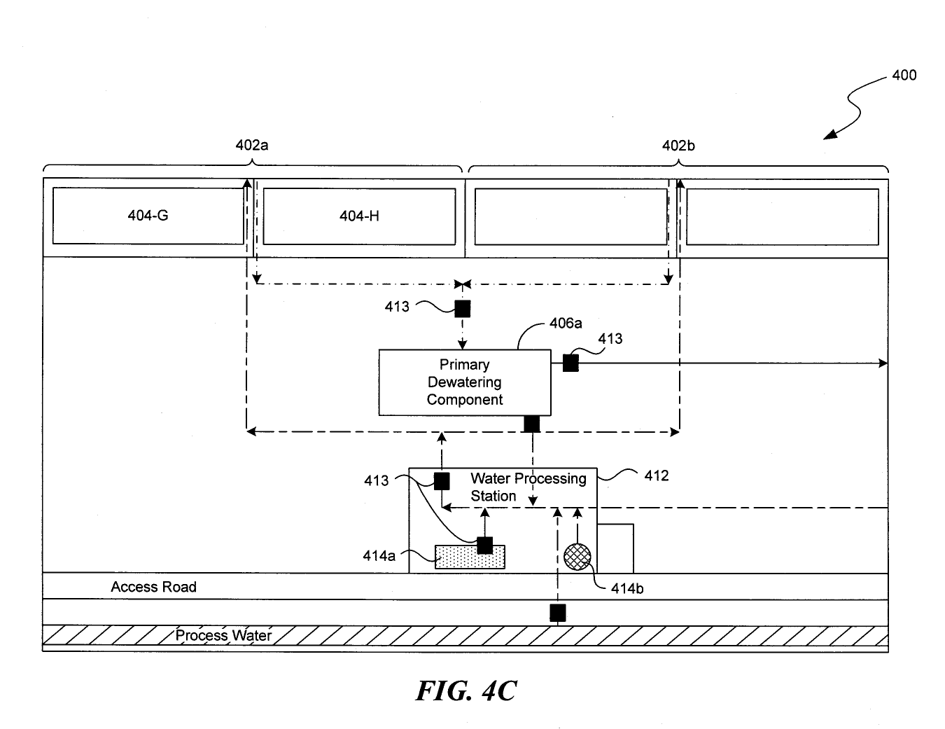

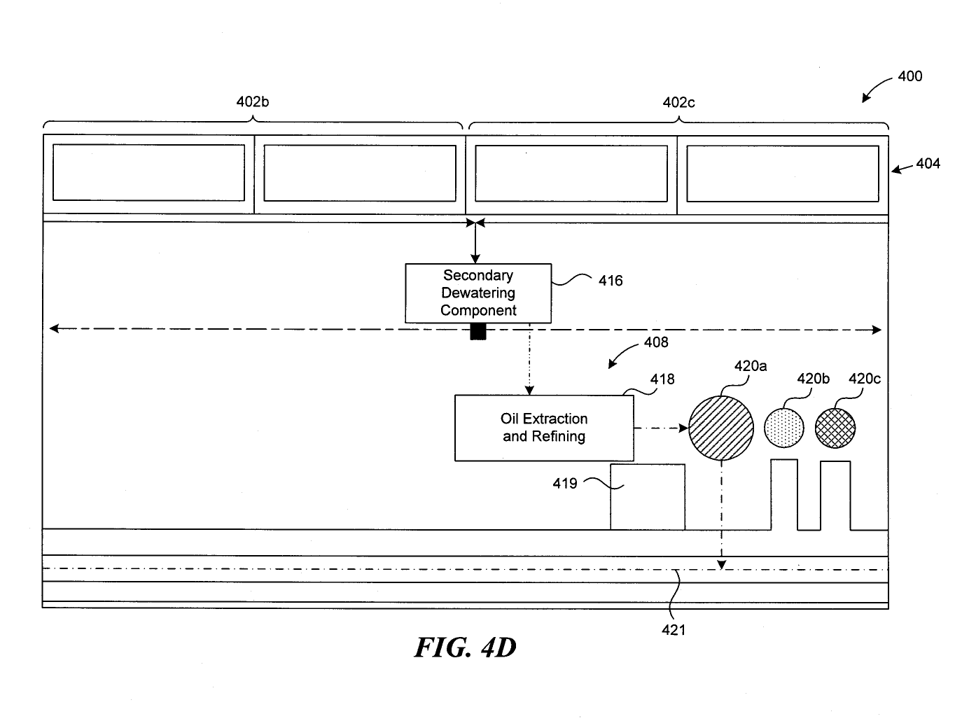

The tubes 110 are initially generally flat and laid up on rolls, spools, or other similar structures before installation. In this way, the tubes 110 can be easily transported and installed (e.g., using tractors or other suitable equipment) at the work site 102. During installation, the individual tubes 110 are laid in parallel across the work site 102. For purposes of illustration, only sixteen individual tubes 110 are shown in FIG. 1. It will be appreciated, however, that any number of tubes 110 may be installed at the work site 102 and/or the tubes 110 may be arranged in a different pattern at the work site 102. Further details regarding algae production installations including the system 100 are discussed in detail below with reference to FIGS. 4A-4D.

The individual tubes 110 can be operably coupled together using generally U-shaped fittings 112. The fittings 112, for example, can fit over end portions 111 of corresponding tubes 110 to join the tubes 110 together. In this way, a single, continuous flow channel 113 is formed within the tubes 110 for the algae culture or medium (not shown). The fittings 112 can be composed of a plastic material or another suitable material. In other embodiments, the fittings 112 may be have a different arrangement and/or the tubes 110 may be coupled together using other suitable devices or techniques. In still other embodiments, the individual tubes 110 may not be directly coupled together, and each tube 110 can function as a single flow channel 113 for the algae culture.

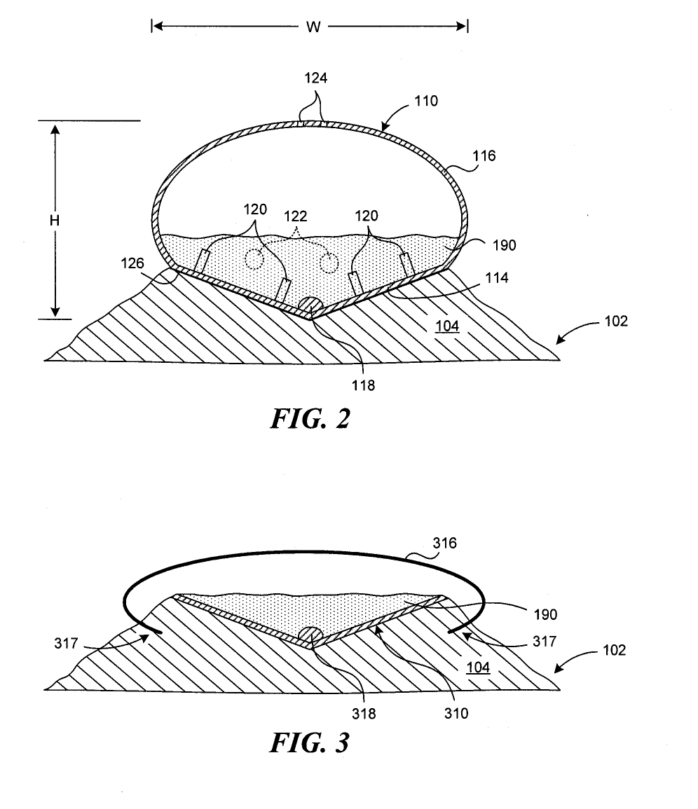

FIG. 2 is a side, cross-sectional view of a single tube 110 taken substantially along lines 2-2 of FIG. 1. Referring to FIGS. 1 and 2 together, the tubes 110 are composed of a generally flexible, thin-walled polyethylene material (e.g., similar to the material used to form drip irrigation tubing). In the illustrated embodiment, the tube 110 has a non-circular cross-sectional profile. More specifically, the tube 110 has a generally V-shaped lower portion 114 and a generally arcuate or curved upper portion 116. The lower portion 114 of the tube 110 is in direct contact with a bed portion 104 of the work site 102, while the upper portion 116 is generally out of contact with the bed portion 104. In other embodiments, the tube 110 can have a different shape and/or configuration. The individual bed portions 104 can be prepared using conventional agricultural methods and practices before installation of the tubes 110. In one embodiment, for example, the V-shaped lower portions 114 and other bed portions 104 can be prepared using techniques similar to those used to prepare cotton fields. In other embodiments, however, the bed portions 104 can be prepared using other suitable methods and/or techniques. Moreover, although the bed portion 104 in FIG. 2 is shown as a raised bed, in other embodiments the bed portion 104 may not be raised relative to the work site 102.

The width W and height H of the tube 110 can be varied to optimize the size of the tube 110 for various applications. A number of different factors (e.g., composition of the algae culture 190, arrangement of the work site 102, side of the bed 104, configuration of the tractor or other equipment used to install the tubing 110, etc.) can be taken into account when determining an optimal size for the tube 110. It will be appreciated, however, that the foregoing list of factors is merely illustrative of several factors that may be considered and is not an exhaustive or conclusive list of factors that may be taken into account.

The tubes 110 can be composed of a generally clear material to allow sunlight to pass through the walls of the tubes 110 and impinge upon the algae culture 190 that is flowed through the tubes 110 over the desired growth period. In addition to helping the algae grow, the sunlight can also help maintain the algae culture 190 within the respective tubes 110 at a desired temperature. One or more of the tubes 110 may also include an ultraviolet (UV) inhibitor, reflective material, and/or coating to help more precisely control the lighting within the tubes 110, and thereby more precisely control the interior temperature of the tubes 110 during operation. In one embodiment, for example, one or more tubes 110 may include a UV inhibitor at least partially embedded within the polyethylene material. In another embodiment, a Fresnel lens, and/or planar waveguide components may be integrated with one or more tubes 110 to help control the lighting. In yet other embodiments, one or more tubes 110 may include a reflective coating or other material (e.g., white paint, etc.) over at least a portion of the tube. In still other embodiments, other materials may be disposed upon and/or incorporated within the material(s) of which the tubes 110 are composed.

The tube 110 can also include an aeration feature 118 at a bottom portion of the tube 110. The CO₂-enriched air is continuously injected into the tube 110 via the aeration feature 118. The aeration feature 118 can include, for example, a polyethylene-based selective barrier material, such as Tyvek® aeration tape commercially available from DuPont of Wilmington, Del. The aeration feature 118 can have a variety of different porosities. In the illustrated embodiment, the aeration feature 118 is an integral portion of the tube 110. For example, the aeration feature 118 can be extruded within the bottom portion of the tube 110 when initially extruding or otherwise forming the tube 110. In other embodiments, however, the aeration feature 118 may not be an integral component of the tube 110. For example, the aeration feature 118 may be adhesively attached to the desired portion of the tube 110 using a suitable adhesive material. One advantage of the aeration feature 118 is that it extends at least approximately along the entire length of the tube 110, thus allowing continuous aeration of the entire algae culture 190 as it flows through the tube 110.

Another advantage of the aeration feature 118 is that the injected CO₂-enriched air creates turbulence within the flow of algae culture or medium 190 through the tube 110. The turbulence within the flow can help prevent build-up of algae on the inner sidewalls of the tube 110, and can enhance mixing of the various components (e.g., water, algae, nutrients, etc.) of which the algae culture or medium 190 is composed. The turbulence can also allow sunlight to reach at least approximately all the portions of the algae culture 190 as it flows through the tube 110. In several embodiments, the tube 110 may also include one or more protrusions, baffles, or vanes 120 (shown schematically) at selected interior portions of the tubes 110. The protrusions 120 are also configured to create turbulence within the flow of algae culture 190. The protrusions 120 can have a variety of different configurations and/or arrangements within the tube 110. For example, the protrusions 120 can be an integral portion of the tube 110, or the protrusions 120 can be separate components that are installed within the tube 110 after the tube is formed.

Several other features may also be incorporated to help inhibit and/or prevent build-up of algae on the sidewalls of the tube 110. In several embodiments, for example, multi-density continuous floating balls 122 (shown in broken lines) may be disposed within the algae culture 190 to help prevent the algae from building up or sticking to the inner sidewalls of the tube 110 and, over time, potentially clogging the tube 110. The balls 122 can have a number of different dimensions, or they may all have at least approximately the same dimensions. In another embodiment, a gel or anti-fouling material (not shown) may be applied to at least a portion of the inner sidewalls of the tube 110 to help prevent build up of algae. Suitable materials include the BLIS anti-fouling gel, commercially available from Teledyne Scientific Company of Thousand Oaks, California.

The tube 110 may also include one or more apertures, openings, or perforations 124 at or proximate to a top portion of the tube 110. The apertures 124 are configured to allow gases within the tube 110 to escape into the external environment. The apertures 124 can have a variety of different configurations and/or arrangements (e.g., air relief valves, open holes, etc.), and can be positioned at a variety of different locations along the length of the tube 110. The apertures 124 are an optional feature and may not be included in some embodiments. In several embodiments, an agricultural mulch material 126 (e.g., a thin plastic film or another suitable material) may be disposed between the tube 110 and the bed 104 The agricultural material 126 can be used to help control temperature, moisture, light exposure, and/or weeds.

Referring back to FIG. 1, the CO₂ subsystem 140 can obtain CO₂ from a variety of different sources, including power plants or generators, ethanol facilities, breweries, food processing centers, landfills, etc. As discussed previously, algae's ability to ingest CO₂ and produce oxygen through photosynthesis is beneficial as a means to curtail carbon emissions. Accordingly, one advantage of the system 100 is that CO₂ emissions from such facilities that would normally be dispersed into the atmosphere can instead be beneficially used within the system 100. Another advantage of this arrangement is that the CO₂ from one of these facilities can help maintain temperature control of the algae culture within the system 100. In other embodiments, however, the CO₂ subsystem 140 can provide CO₂ to the system 100 from other suitable sources.

The fresh medium subsystem 150 is operably coupled to one or more of the tubes 110 via first or input manifolds 152 (e.g., plastic irrigation pipe (PIP) header manifolds). As discussed previously, the fresh medium subsystem 150 is configured to provide a solution containing water, nutrients (e.g., N—P—K and micronutrients), and an initial portion or inoculum of algae (e.g., approximately ½ g/L to 1 g/L) to the system 100. A variety of different algae strains may be used with the system 100. In several embodiments, the fresh medium subsystem 150 may also be configured to use byproducts from other natural sources (e.g., dairy farms, waste water treatment facilities, runoff from other facilities, etc.) for at least a portion of the fertilization solution. In still other embodiments, other sources of fertilization materials (e.g., liquid or drip fertilization materials, etc.) may be used. In several embodiments, at least a portion of the fresh medium subsystem 150 may be installed below ground. One advantage of this arrangement is that it can provide a means of temperature control for the components of the fresh medium subsystem 150. For example, the buried portions of the fresh medium subsystem 150 can be relatively easy to maintain at a generally constant temperature during both the summer and winter months.

The harvesting subsystem 160 is operably coupled to one or more of the tubes 110 via second or collection manifolds 162 (e.g., PIP collection manifolds). At the end of the desired growth cycle (e.g., 48 hours), the resulting algae culture 190 (FIG. 2) enters the collection manifolds 162 and can be split into two or more portions. In one embodiment, for example, the algae culture is split into two approximately equal portions, and (a) a first culture portion (not shown) is returned to the input manifolds 152 where it is mixed with incoming, fresh algae medium and diluted to a desired concentration (e.g., approximately ½ g/L to 1 g/L of algae), and (b) a second culture portion (not shown) is sent on for harvesting. In other embodiments, however, the algae culture may be split into a different number of portions before harvesting and/or the algae culture may not be divided into portions.

In the illustrated embodiment, the second culture portion is initially sent to a dewatering component 164 where fluids are removed from the portion, thus significantly increasing the concentration of the algae within the culture (e.g., an increase of approximately 500% or more). The concentrated culture is then sent to an oils extraction component 166 for further processing, after which the culture is conveyed to either an algal oils component 168 or algal solids component 169 for final extraction steps. The resulting final product(s) are then ready for storage or transport (e.g., via pipeline, truck, etc.) to a desired location. It will be appreciated that the foregoing is merely illustrative of one particular harvesting approach using the harvesting subsystem 160. In other embodiments, a variety of different harvesting techniques and/or practices may be used. Moreover, in still other embodiments the harvesting subsystem 160 may have a different arrangement and/or include a number of different features.

One advantage of the system 100 is that the system is scalable and can be implemented in a variety of different sizes and/or arrangements. The various components of the system 100 can be specifically tailored for any desired work site configuration. As described below with reference to FIGS. 4A-4D, for example, an algae production facility or subfarm configured in accordance with an embodiment of the disclosure can include a number of systems 100 installed on fields arranged at least proximate to each other.

Another advantage of the system 100 is that the location of the work site 102 is not constrained by the location of the CO₂ subsystem 140, the fresh medium subsystem 150, and/or the harvesting subsystem 160. Rather, one or more of these components can be located remotely from the work site 102 and the required inputs can be provided via a pipeline or another suitable method. Still another advantage of the system 100 is that the tubes 110 and associated components can be quickly and easily installed with common agricultural equipment and processes. Accordingly, the system 100 is expected to cost significantly less to both install and maintain than conventional algae production systems.

FIG. 3 is a side, cross-sectional view of a trough or growth container 310 configured in accordance with another embodiment of the disclosure. The trough 310 can be used with the algae production system 100 of FIG. 1 or another suitable algae production system. The trough 310 can have a number of features generally similar to the tube 110 described above with reference to FIGS. 1 and 2. For example, the trough 310 includes a generally V-shaped portion in contact with a corresponding bed portion 104 of the work site 102. The trough 310 also includes an aeration feature 318 generally similar to the aeration feature 118 described previously. The trough 310 can be composed of materials generally similar to the tube 110.

The trough 310, however, differs from the tube 110 in that the trough 310 has an open configuration and does not include an integral upper or cover portion. Instead, the trough 310 is, at least initially, open to the external environment. Agricultural mulch material 316 (e.g., a thin plastic film or another suitable material) can be disposed over the trough 310 and the algae culture 190 within the trough 310. As discussed previously, the agricultural material 316 is configured to control temperature, moisture, and/or light exposure for the algae culture 190 in the trough 310. Further, in several embodiments the agricultural material 316 can be colored or include UV filters or the like to help precisely control the light exposure. The agricultural material 316 can be releasably secured to the bed portion 104 by embedding end portions 317 of the material 316 into the bed 104 or using other suitable techniques. In other embodiments, the agricultural material 316 can have a different configuration and/or can be composed of a different material.

FIGS. 4A-4D are schematic, top plan views of an algae production facility or subfarm 400 configured in accordance an embodiment of the disclosure. As shown in FIG. 4A, for example, the subfarm 400 can include a number of blocks or modules 402 arranged relative to each other at a work site 301. In the illustrated embodiment, for example, the subfarm 400 includes four blocks 402 (identified individually as 402a-d) approximately adjacent to each other in a grid pattern. In other embodiments, however, the blocks 402 can be arranged differently relative to each other. Each block 402 includes one or more fields 404. In the illustrated embodiment, for example, the blocks 402a-d each include eight fields 404. For purposes of illustration, only fields 404-A to 404-H of block 402a are specifically identified. Each field 404 can include an algae production system (e.g., the system 100 of FIG. 1) configured to cultivate and grow algae. Further details regarding the individual fields 404 are described below with reference to FIG. 4B.

Each block 402a-d has a first dimension or length D₁ and a second dimension or width D₂. In one embodiment, for example, the first dimension Dᵢ can be approximately 1 mile and the second dimension D₂ can be approximately ½ mile. The subfarm 400 can accordingly have an area of approximately 1280 acres. In other embodiments, however, the first and/or second dimensions D₁ and D₂ can vary.

The subfarm 400 can also include one or more dewatering components 406 (two are shown as first and second dewatering components 406a and 406b). The first dewatering component 406a is operably coupled to blocks 402a and 402b, and the second dewatering component 406b is operably coupled to blocks 402c and 402d. The first and second dewatering components 406a and 406b are in turn operably coupled to one or more oil processing components 408. The dewatering components 406 and oil processing component 408 are described in greater detail below with reference to FIGS. 4C and 4D. In other embodiments, the subfarm 400 may include a different number of dewatering components 406 or oil processing components 408 and/or the dewatering and oil processing components may have a different arrangement.

FIG. 4B is a schematic, top plan view of a single field (e.g., Field 404-A) of the subfarm 400. The field 404-A can include a number of beds 410 (e.g., 166 beds) arranged generally parallel to each other. In one particular embodiment, each bed 410 has a width of approximately 60 inches, a height of approximately 10 inches, and a length of approximately 1250 feet. The individual beds 410 are approximately 30 inches apart from each other to allow personal access and equipment access to the area. In other embodiments, the beds 410 can have different dimensions. Each bed 410 can also include a non-circular tube 110 (FIG. 2) or trough 310 (FIG. 3) configured to carry a flow of an algae culture or medium (not shown). As described above with reference to FIGS. 1 and 2, a growth medium containing water, N—P—K and micronutrients, and an initial inoculum of algae culture or medium (e.g., approximately ½ g/L to 1 g/L) is supplied to the trough or tube (not shown) in each bed 410. The volumes of the various components within the growth medium can be calculated based on a nominal algal elementary content, anticipated growth rates, CO₂ uptake efficiency, and other associated factors. The algae culture is flowed for a desired growth time (e.g., 48 hours) while the algae culture is aerated using CO₂-enriched air. In other embodiments, the individual fields 404 can have a different arrangement, different dimensions, and/or include different features.

FIG. 4C is a schematic, top plan view of the primary dewatering component 406a. Although only a single dewatering component is shown, it will be appreciated that some or all of the dewatering components (e.g., the dewatering component 406b of FIG. 4A) of the subfarm 400 can have similar features and configurations. The dewatering component 406a can have a number of features generally similar to the dewatering subsystem 150 described above with reference to FIG. 1, and can function in generally the same way as the dewatering subsystem 150.

The dewatering component 406a is operably coupled to each of the fields 404 in blocks 402a and 402b. Multiple pumps 413 can be operably coupled to various components of the subfarm 400 to help facilitate movement of the algae culture and other inputs (e.g., water, nutrients, etc.) within the system. The dewatering component 406a can also be operably coupled to a water processing station 412. In several embodiments, the water processing station 412 is configured to supply water to the subfarm 400 from local water sources (e.g., via pipeline or canal). The water processing station 412 can be operably coupled to an N—P—K/micronutrient subcomponent 414a and a chlorine subcomponent 414b. After a desired growth period, the algae culture (not shown) from blocks 402a and 402b can be sent to the dewatering component 406a and concentrated as part of the harvesting process. In one embodiment, the dewatering component 406a is configured to handle a flow of approximately 7,500 gallons per minute (gpm). In other embodiments, however, the dewatering component 406a can have a different configuration and/or include different features.

FIG. 4D is a schematic, top plan view of the oil processing component 408. Although only a single oil processing component 408 is shown, it will be appreciated that the subfarm 400 may include one or more additional oil processing components 408. As mentioned previously, the oil processing component 408 is configured to receive concentrated algae culture from the dewatering components 406a and 406b (FIGS. 4A and 4C). In several embodiments, the algae culture may pass through an optional secondary dewatering component 416 before harvesting. The secondary dewatering component 416, for example, can further concentrate the culture. The secondary dewatering component 416, however, may not be included in several embodiments.

The oil processing component 408 can include an oil extraction and refining component 418 positioned to receive the concentrated algae culture. The oil processing component 408 may also include a dry biomass commodity facility 419. After further processing and extraction, the resulting final products can be sent to one or more storage facilities 420 (three are shown as first, second, and third storage facilities 420a-c) or transported to a desired location for use. The storage facilities 420 can include separate facilities for final products that meet specific criteria (e.g., particular strains, chemical compositions, intended use, etc.). In the illustrated embodiment, for example, the first storage facility 420a can be a Triacylglycerides (TAG)/Fatty Acid (FA) two-day storage facility, the second storage facility 420b can be an Eicosapentaenoic acid (EPA) two-day storage facility, and the third storage facility 420c can be a carotenoids seven-day storage facility. In other embodiments, a variety of different storage facilities 420 may be used, and/or the storage facilities 420 may have a different configuration or arrangement. The subfarm 400 may also optionally include one or more pipelines 421 configured to transport the final algae product to remote location(s).

In several embodiments, the subfarm 400 is expected to generate an annual yield of approximately 40-60 tons of dry algae mass per gross acre. The dry algae mass is expected to have an oil content of approximately 10-40%. The expected annual yield and/or oil content range can vary, however, based on a number of conditions, such as sunlight, temperature, sources of CO₂ and nutrients, algae strain used, and/or emphasis on oil production versus carbohydrate/protein production. In several embodiments, the subfarm 400 can utilize algae strains that are specifically tailored to balance oil, starch, and proteins. In other embodiments, however, a variety of different algae strains having various characteristics or features can be used. The expected annual yield and oil content ranges are provided herein merely as examples, and in other embodiments the subfarm 400 can produce a different yield of dry algae mass and/or the resulting dry algae mass can have a different oil content.

From the foregoing, it will be appreciated that specific embodiments have been described herein for purposes of illustration, but that the disclosure encompasses additional embodiments as well. For example, the system 100 and/or subfarm 400 described above can include a number of different components to provide CO₂ or nutrients, and can adapted for use within a wide range of environmental conditions (e.g., landscape, sunlight and temperature conditions, etc.). Moreover, in at least several embodiments, the system 100 and/or subfarm 400 can be configured to utilize saline water in addition to, or in lieu of, fresh water. Specific elements of any of the foregoing embodiments can be combined or substituted for elements in other embodiments. For example, the subfarm 400 can include a number of additional or different hardware components. Furthermore, while advantages associated with certain embodiments of the disclosure have been described in the context of these embodiments, other embodiments may also exhibit such advantages, and not all embodiments need necessarily exhibit such advantages to fall within the scope of the invention. Accordingly, embodiments of the disclosure are not limited except as by the appended claims.

I/We claim:

1. An algae production system, comprising:
a plurality of elongated growth receptacles arranged in a desired configuration at a work site, wherein the growth receptacles are configured to hold an algae culture, and wherein the individual growth receptacles have a generally non-circular cross-sectional profile;
a carbon dioxide (CO₂) subsystem operably coupled to at least one of the growth receptacles and configured to supply provide CO₂-enriched air to the growth receptacles;
a fresh medium subsystem operably coupled to at least one of the growth receptacles and configured to supply a fertility solution to the growth receptacles; and
a harvesting subsystem operably coupled to at least one of the growth receptacles and configured to receive the algae culture after a desired growing period.

2. The algae production system of claim 1 wherein the individual growth receptacles include a tube having a generally V-shaped lower portion and an arcuate upper portion.

3. The algae production system of claim 1 wherein the individual growth receptacles include a trough having a generally V-shaped cross-sectional shape.

4. The algae production system of claim 3 wherein the trough has a first side facing the work site and a second side facing opposite the first side, and wherein the system further comprises an agricultural mulch material over at least approximately all of the second side of the trough.

5. The algae production system of claim 1 wherein the growth receptacles are composed of a generally flexible, polyethylene material.

6. The algae production system of claim 1 wherein the growth receptacles are composed of a generally clear material.

7. The algae production system of claim 1 wherein the individual growth receptacles include an aeration feature at least proximate to a lower portion of the growth receptacle.

8. The algae production system of claim 7 wherein the aeration feature includes a polyethylene-based selective barrier material.

9. The algae production system of claim 7 wherein the aeration feature is an integral component of the growth receptacle.

10. The algae production system of claim 7 wherein the aeration feature is a discrete component that is adhesively attached to the growth receptacle.

11. The algae production system of claim 7 wherein the aeration feature extends along at least approximately the entire length of the corresponding growth receptacle.

12. The algae production system of claim 1 wherein the work site includes a plurality of beds arranged generally parallel with each other, and wherein each bed is positioned to receive a growth receptacle, and further wherein at least a portion of each growth receptacle is in direct contact with the corresponding bed.

13. The algae production system of claim 1 wherein the individual growth receptacles have a length greater than approximately 1000 feet.

14. The algae production system of claim 1 wherein the individual growth receptacles have a length of approximately 1250 feet.

15. The algae production system of claim 1 wherein the individual growth receptacles further include a UV inhibitor on and/or in the material of which the individual growth receptacles are composed.

16. The algae production system of claim 1 wherein the individual growth receptacles include an inner sidewall portion and one or more protrusions projecting inwardly from the inner sidewall portion, wherein the one or more protrusions are positioned to contact at least a portion of the algae culture.

17. The algae production system of claim 1, further comprising a plurality of multi-density balls disposed within at least a portion of the individual growth receptacles and positioned to contact at least a portion of the algae culture.

18. The algae production system of claim 1 wherein the growth receptacles are arranged generally parallel to each other across at least a portion of the work site, and wherein the system further comprises a plurality of generally U-shaped fittings configured to operably couple end portions of adjacent growth receptacles together.

19. The algae production system of claim 1, further comprising an agricultural mulch material between the individual growth receptacles and the work site.

20. The algae production system of claim 1, further comprising the algae culture.

21. The algae production system of claim 1 wherein the growth receptacles are first growth receptacles arranged generally parallel with each other at a first work site, and wherein the system further comprises one or more additional second work sites at least approximately adjacent to the first work site, and wherein each of the second work sites includes a plurality of growth receptacles arranged generally parallel with each other and disposed over at least a portion of the corresponding second work sites.

22. The algae production system of claim 21 wherein the CO₂ subsystem, the fresh medium subsystem, and harvesting subsystem are operably coupled to each of the growth receptacles at the first work site and the one or more second work sites.
